(19) United States
(12) Patent Application Publication
(10) Pub. No.: US 2003/0112573 A1
(43) Pub. Date: Jun. 19, 2003

(54) Method and apparatus for preventing overload in a circuit

(76) Inventor: Daniel Perez, Foothills Ranch, CA (US)

Correspondence Address: LEVIN & HAWES, P O BOX 4140, LAGUNA BEACH, CA, 92652

(21) Appl. No.: 10/017,069

(22) Filed: Dec. 13, 2001

(51) Int. Cl. H02H 3/00

(52) U.S. Cl. 361/115

(57) ABSTRACT

A fuseless power supply regulator circuit is provided for a gate security system. The circuit has sub-circuitry and components to monitor current levels of current from an unregulated power supply and to stop the follow of current into the circuit when the unregulated supply is providing an excessive amount of current and/or the gate security system is drawing an excessive amount of current as a result of a short or otherwise. The sub-circuitry continues to monitor current levels of current coming from the unregulated power supply and when the current levels drop to acceptable levels reopens the main circuit and allows current to flow into the power supply regulation circuit and on into the power supply circuit.

### FIELD OF THE INVENTION

The present invention relates to method and apparatus for preventing a circuit overload. More particularly it relates to a fuseless method and apparatus that prevents circuit overload in a security system and automatically resets the system for continued operation after correction of the problem causing the overload.

### BACKGROUND OF THE INVENTION

Security systems that provide limited access to gated communities and other restricted access areas rely on various types of power supplies to operate the gate, gate controller and related accessories. Often these are unregulated DC or AC power supplies. In order to provide the circuit with a constant and consistent flow of current at required voltage levels the system includes a voltage regulator. Typically the voltage regulator also includes a fuse or circuit breaker to protect the system from overload.

An overload generally occurs when current entering the circuit becomes excessive and reaches levels that can damage or destroy the circuit. A fuse typically is a filament encapsulated in glass or some other inert non-conductive material. When a fuse is placed in a circuit if the circuit experiences an overload the filament of the fuse burns out and thereby shuts the circuit down. A circuit breaker works in a similar fashion, when the circuit experiences an overload due to excessive current the heat generated by the overload causes the breaker to open and shut the system down.

Thus, when the current levels reach excessive levels based on the tolerances of the fuse, it burns out or the circuit breaker opens to create an open circuit and thus protect the circuit. However, once the fuse bums out or the circuit breaker opens, the system needs servicing. In order to reset the circuit and make it operational, power to the circuit has to be shut off, the fuse replaced or breaker reset, the problem causing the overload identified and corrected, and the power turned back on. Such a procedure can be costly and time consuming. Since most gate security systems operate outdoors they are particularly susceptible to problems that can cause an overload of the circuit. These can include small animals or insects crawling into the housing and causing a short in the circuit. Heavy rain or excessive humidity can also cause shorts and temporary overloads. Since such events can often happen at inopportune times when a trained technician is not available, those depending on the security system for access to and from a restricted area served by the malfunctioning security system are left without an adequate alternative short of shutting the system down and leaving the gate open until it can be serviced. Additionally, the cause of the overload can be a transient occurrence that may correct itself or readily apparent cause that can be easily corrected. In such an instance the power to the system still has to be shut down, the fuse replaced or circuit breaker reset and the power turned back on. Additionally, if a technician is called for service to the unit they often have to go through a trial and error process of shutting the power off, determine the cause, reset the breaker or fuse and turn it back on, perhaps several times before determining what the problem causing the overload is.

Thus, what is needed is gate security system that will automatically reset itself and recommence operation as soon as the problem causing the overload is removed. A system that does not require a trial and error troubleshooting process of shutting down of power to the system and replacement of fuses or resetting of circuit breakers several times until the cause of the overload or short is finally discovered.

### SUMMARY

It is an objective of the present invention to provide a system and method for monitoring current levels in the circuitry of a security system and protecting its circuits from an overload and resetting the circuit for continued operation without the need for replacing fuses and resetting circuit breakers upon removal of the conditions causing the overload.

These and other objectives are achieved by providing a fuseless security system power supply circuit with overload protection that includes: a) a current sensor for sensing the levels of current entering a circuit; b) a controller that monitors current levels sensed by said current sensor; c) a switch responsive to said controller wherein said controller opens said switch to thereby turn off current entering the circuit when a specific current level is sensed; and d) wherein said controller continues to periodically senses current levels at said current sensor and closes said switch when current levels reach a preset level and thereby allow current to flow into the circuit again.

In a further aspect of the present invention it monitors voltage being provided to the security system and provides a regulated supply of voltage to the circuitry of the security system. In yet another aspect of the system when it is experiencing an overload condition, it momentarily allows the circuitry of the security system to draw current to determine if the security circuitry will continue to draw an excessive amount of current and thereby determine if the security system can be reset and allowed to recommence operations.

In another aspect of the present invention it provides a method for preventing overload in a security system circuit, the method includes the following steps of: a) monitoring current levels of current entering a security system circuit; b) shutting the circuit down when the current levels reach a preset level; c) indicating that the circuit is experiencing and overload; d) continuing to sample the current being supplied for the circuit; e) determining when the current levels of the current being supplied to the circuit have fallen to acceptable levels; f) resetting the circuit to accept current for operation after determining the current levels have fallen to acceptable levels; and g) continuing to monitor the current levels after resetting of the circuit. In yet a further aspect of the method includes momentarily allowing the circuit to draw current to determine the levels at which the circuit is drawing current have returned to acceptable levels.

### BRIEF DESCRIPTION OF THE DRAWINGS

The invention will be better understood by an examination of the following description, together with the accompanying drawings, in which:

FIG. 1 is a block diagram of the major functional components of a preferred embodiment of the present invention;

FIG. 2 is a schematic diagram of discrete circuit elements that make up a preferred embodiment of the present invention; and

FIG. 3 is a flow chart depicting the operation of a preferred embodiment of the present invention.

### DETAILED DESCRIPTION OF THE PREFERRED EMBODIMENT

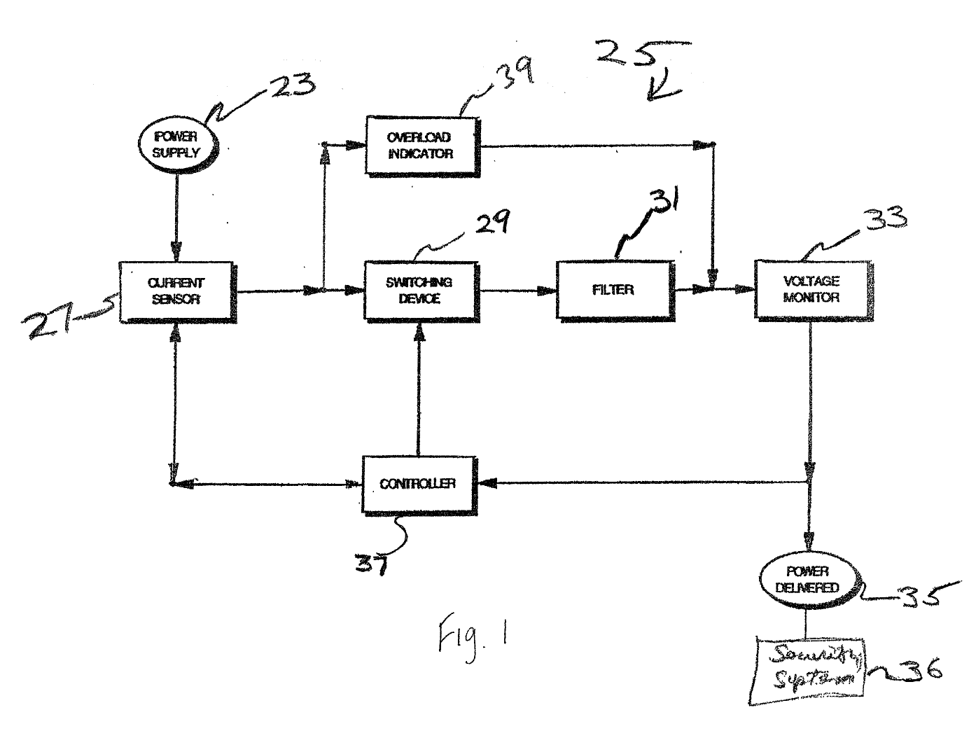

FIG. 1 provides a block type of diagram of the major functional parts of a preferred embodiment of the present invention. Electrical power supplied by power supply 23 to system 25 first passes through current sensor 27. During normal operation the current passes through switching device 29 and then onto filter 31 and finally through voltage monitor 33 and then on into the system 36 for which the power 35 is being supplied. The variety of systems to which the power can be supplied are too numerous to mention suffice it to say that in one preferred implementation the system 25 would be providing power to a security system 36.

Controller 37, in a preferred embodiment of the invention, monitors both the current levels from power supply 23 and the voltage levels at voltage monitor 33. If the controller 37 in monitoring current sensor 27 determines that the current levels have increased to the point that the system is carrying too much of a load it stops the flow of current and thereby shuts the system down by activating switching device 29. When the system activates switching device 29 to shut the system down, indicator 39, an LED or similar device, turns on to signal an overload or short exists in the system. At this point controller 37 will continue to monitor with current sensor 27 the current levels from power supply 23. When the current levels fall to a safe level controller 37 will activate switching device 29 and thereby allow current to flow through filter 31 and voltage monitor 33 into the system 36 to which power is being supplied. Consequently, controller 37 and current sensor 27 replace the standard fuse or circuit breaker that are almost universally used to prevent overload in the circuits of electrical systems utilized to prevent damage to these circuits. However, controller 37 does even more than this. A circuit or system protected by a fuse or circuit breaker typically requires the termination of power to the system and either the physical replacement of the fuse or the resetting of the circuit breaker. If the problem causing the overload has not been properly diagnosed and corrected the fuse or circuit breaker will again blow and require the system be disconnected again from the power supply while the system is again examined to determine the cause of the overload. Once determined the system is again reconnected to the power supply after the fuse is replaced or circuit breaker reset. This can continue for some time until the problem is solved.

On the other hand controller 37 together with current sensor 27 act in a sense as a “smart fuse or breaker”. Controller 37 continues either continuously or periodically to monitor the current levels in sensor 27 and when the levels drop to a predetermined safe level activates switching device 29 and thereby automatically reset system 25 to recommence providing power. Assuming the individual trouble shooting the circuit takes proper precautions when working on the circuit to avoid injury or it is a low enough power system that it will not injure the person working on the system this eliminates the time consuming need turn the power off and reset the system after possible causes of the overload are explored. As soon as the problem is discovered and removed the system will automatically reset itself and recommence supplying power. The present invention has the additional advantage in that it will automatically reset itself and recommence operations without outside intervention after being disrupted by transient problems that cause an overload but pass or clear up on their own. Such transient phenomena can be caused by power surges from an unregulated power supply or other sources, dampness that may be caused by a rain storm but clears up when the sun or dry weather returns etc.

The cause of the overload could be a problem in the power supply regulator circuitry 25 or the security system 36, such as a short. Consequently, in a preferred embodiment of the present invention the controller 37 periodically for momentary periods turns on switch 29 to determine if the regulator circuitry or the security system circuitry will continue to draw excessive amounts of current. Naturally, if the regulator circuitry 25 or the security system 36 circuitry continue to draw excessive amounts of current it will continue to keep switch 29 shut off. On the other hand if it determines, based on readings from current sensor 27 that the regulator circuitry 25 or the security system circuitry 36 no longer draws excessive amounts of current it will turn switch 29 back on to allow the system to recommence normal operations. At the same time controller 37 is monitoring current sensor 27 it is also monitoring through voltage monitor 33 the voltage levels of the power the system 25 is supplying to the security system 36. Controller 37 is also activating and deactivating switching device 29 in a set pattern to assure that system 25 is providing a steady and uniform supply of power at a preset voltage level.

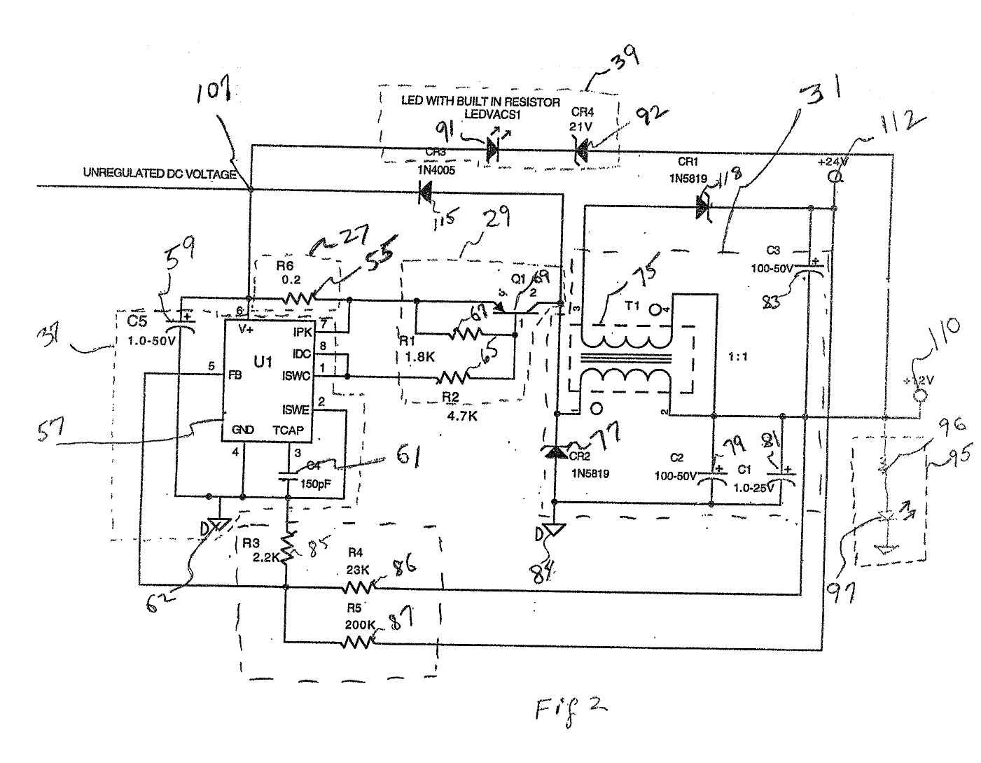

FIG. 2 is a schematic circuit diagram of a preferred embodiment of the present invention that forms a DC to DC regulated power supply. Although, the preferred embodiment described herein discloses a DC to DC type power supply converter-regulator, those skilled in the art after having read and understood the present specification will readily understand that it can be used with other types of circuits and power supplies and still accomplish the objectives of the present invention.

The functional elements depicted in FIG. 1 appear in a detailed fashion with the components that make them up in the preferred embodiment depicted in FIG. 2. Dashed boxes outline the components that make up each of the functional elements of FIG. 1. Current sensor 27 consists of a resistor 55, the value of which determines the overcurrent threshhold. Controller 37 consists of IC chip 57, input filtering capacitor 59, switching frequency capacitor 61 and ground 62. Switching device 29 consists of resistor 65, resistor 67 and transistor 69. Filter 31 consists of transformer 75, diode 77, diode 118, capacitor 79, capacitor 81, capacitor 83 and ground 84. Voltage monitor 33 consists of resistors 85, 86 and 87. Overload indicator 39 consists of light emitting diode 91 and diode 92. The system also includes a power supply indicator 95 to show when the system is operating normally and providing power. The power supplier indicator consist of resistor 96 connected to light emitting diode 97 that in turn attaches to ground 98.

Power from and unregulated DC voltage supply enters the system at junction 107 and exits the system at junction 110 and 112. In the system depicted in FIG. 2 the values of the individual components have been selected to produce a 12 volt regulated supply at junction 110 and a 24 volt regulated supply at junction 112.

Diode 115 functions as an energy dump to discharge capacitors 79 and 81 whenever external input power 107 is removed. Diode 118 functions as a rectifier to control the one way flow of current to juncion 110 and junction 112.

Controller 37 forms the heart of the system depicted in FIG. 2 and will be described in detail as to how it functions. Controller 57 internally consists of 4 circuits, a) switching oscillator, b) switch drive, c) reference comparator, and d) reference regulator. Pin 6 is the power input that supplies power to the controller while pin 4 is the ground input. The switching oscillator is a freerunning oscillator whose frequency is dependent upon the value of capacitor connected to pin 3 and can be shut down by a voltage on pin 7 300 millivolts less than the voltage present on power input pin 6. This input is the overcurrent sensing (refer to resistor 27, FIG. 2). The switch drive is driven by the switch oscillator and consists of drive collector pin 8, switch collector pin 1, and switch emitter pin 2 connected to switch 29, FIG. 2. The reference comparator is biased by the reference regulator and feedback pin 5. Whenever the feedback pin voltage exceeds the 1.25 volt reference generated by the reference regulator, the reference comparator will turn off the switch drive circuit. Typically, the feedback pin serves to provide an overvoltage shutdown to the switching system.

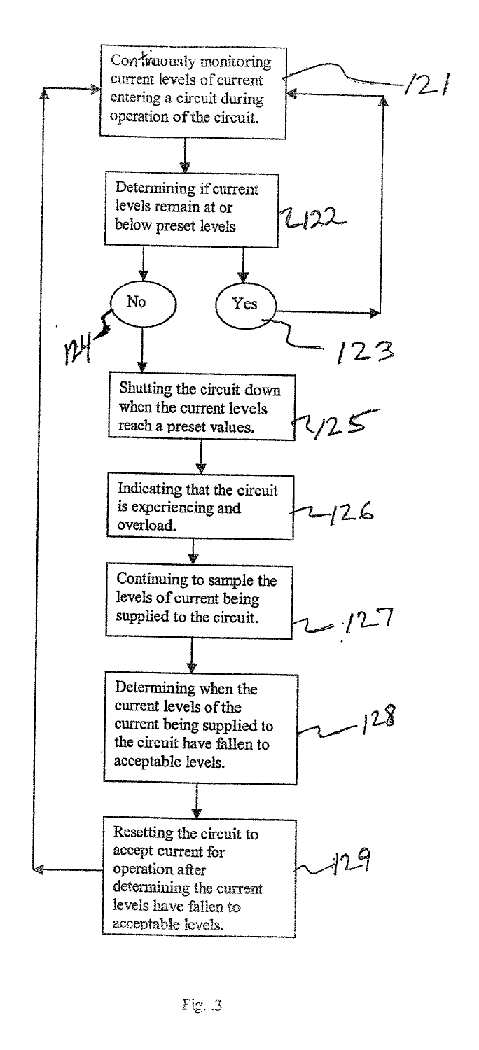

The method of the system works such that it continuously monitors current levels of the system 121 (FIG. 3). In continuously monitoring the current levels the system determines if the current levels remain at or below the preset levels 122. If the current levels remain at or below the preset levels the system continues on with normal operation. As soon as the system senses that current levels exceed the preset parameters 124 it then shuts the power source off from the rest of the system to protect it from an overload 125. The system also indicates that it is experiencing and overload 126. The circuit continues to sample current levels 127. Each time the system of the present invention samples the current levels it does so to determine if the current levels remain at an excessively high level or if they have fallen to acceptable levels 128. If the system determines the current levels have fallen to acceptable levels it will reset the power supply circuit 129 to allow the renewed supply of power to security system. The system continues to monitor current levels after resetting the circuit to determine if the current being drawn remains within acceptable parameters 121, 122 and 123. In a preferred embodiment of the invention the step of continuing to sample the current levels being supplied 127 includes momentarily turning on switch 29 (FIGS. 1 and 2) to determine at what level the regulatory circuitry 25 and the security system circuitry 36 are drawing current and determine if the cause of the overload problem lies in the circuitry of regulatory circuitry 25 or the security system 36.

While the invention has been particularly shown and described with reference to a preferred embodiment thereof, it will be understood by those skilled in the art that various changes in form and detail may be made to it without departing from the spirit and scope of the invention.

We claim:

1. A fuseless security system power supply circuit with overload protection comprising:
a. a current sensor for sensing the levels of current entering a circuit;
b. a controller that monitors current levels sensed by said current sensor;
c. a switch responsive to said controller wherein said controller opens said switch to thereby turn off current entering the circuit when a specific current level is sensed; and
d. wherein said controller continues to periodically senses current levels at said current sensor and closes said switch when current levels have fallen below the preset level and thereby allow current to flow into the circuit again.

2. The circuit of claim 1 wherein voltage produced by the circuit is regulated.

3. The circuit of claim 2 further comprising a voltage monitor for monitoring voltage produced by the circuit and said controller regulates voltage levels produced by said circuit based on readings from said voltage monitor to which said controller is actively connected.

4. The circuit of claim 3 further comprising a filter to filter the voltage generated by the circuit.

5. The circuit of claim 1 wherein said switch further comprises a circuit that includes a semiconductor device actively connected to said controller to perform the switching function in response to a signal from said controller.

6. The circuit of claim 1 further comprising a power indictor and an overload indicator actively attached to the circuit to respectively signal the circuit is operating within normal parameters or is in an overload condition.

7. The circuit of claim 1 wherein said controller after shutting off said switch as the result of sensing preset current levels periodically turns on said switch for a momentary period of time to determine if preset or greater amounts of current will still be continued to be drawn.

8. A method for preventing overload in a security system circuit comprising the steps of:
a) monitoring current levels of current entering a security system circuit;
b) shutting the circuit down when the current levels reach a preset level;
c) continuing to sample the current being supplied for the circuit;
d) determining when the current levels of the current being supplied to the circuit have fallen below the preset levels;
e) resetting the circuit to accept current for operation after determining the current levels have fallen below the preset levels; and
f) continuing to monitor the current levels after resetting of the circuit.

9. The method of claim 8 wherein the step of monitoring the current levels to determine if they have returned to acceptable levels includes: momentarily allowing the circuit to draw current to determine the levels at which the circuit is drawing current and determine if they have fallen below the preset levels.

10. The method of claim 8 comprising the additional steps of providing a regulated power supply.

11. The method of claim 8 comprising the additional step of indicating that the circuit is experiencing an overload.
